(19) United States
(12) Patent Application Publication
(10) Pub. No.: US 2007/0138706 A1
(43) Pub. Date: Jun. 21, 2007

(54) Method for preparing metal ceramic composite using microwave radiation

(75) Inventors: John David Metzger, North Huntingdon, PA (US); Manju Singh, Coram, NY (US)

Correspondence Address: DILWORTH & BARRESE, LLP, 333 EARLE OVINGTON BLVD., SUITE 702, UNIONDALE, NY, 11553, US

(73) Assignee: Amseta Corporation

(21) Appl. No.: 11/312,146

(22) Filed: Dec. 20, 2005

(51) Int. Cl. H05B 6/64

(52) U.S. Cl. 264/432

(57) ABSTRACT

A process based on the microwave-induced pyrolysis of an actively seeded, high-purity preceramic polymer for the rapid fabrication of low-cost and net-shape, provides silicon carbide and other ceramic components with specifically tailored compositions and multifunctional properties. The microwave processing method enables the microwave-induced pyrolysis of a polymer precursor that has been seeded with low volume fractions (about 5%) of nanometer-sized metal and/or dielectric fillers. The proper choice of the size of the filler particles, the volume content of the filler and the material type of the filler enables the effective direct coupling of the microwave energy to pyrolyze the preceramic polymer.

### BACKGROUND OF THE INVENTION

1. Field of the Invention

The present invention generally relates to a method for preparing a metal ceramic composite, and in particular, to a method for preparing a metal ceramic composite using microwave-induced pyrolysis.

2. Description of the Related Art

High-performance ceramics such as silicon carbide, aluminum nitride, boron carbide, titanium nitride and the like, are well suited for applications such as rocket nozzles, land-based energy generation, and automobile parts. Ceramic materials that can be fabricated as net-shape components, such as films, coatings, fibers, or in bulk shapes, are especially useful for practical applications. The ceramic materials are generally prepared from powders by employing a sequence of synthesis processing, shaping, and sintering steps. However, in the last two decades, there has been considerable interest in the development of alternative powder-free chemical methods for preparing advanced ceramics. Since the discovery of polycarbosilane and its subsequent demonstration as a silicon carbide precursor, various polymeric precursors to silicon carbide, and other ceramics, have been formulated and proposed, primarily as binder materials for ceramic powders in the preparation of sintered ceramic monoliths.

Polymer precursors, or preceramic polymers are organoelement polymers that are converted from polymer to ceramic when heated at temperatures above 800° C. They are typically used to obtain non-oxide ceramics; e.g., SiC, SiNC, SiNBC, Si₃N₄, SiOC and BN. The fabrication of ceramics by pyrolysis of preceramic polymers can provide highly three-dimensionally covalent refractory components such as fibers, films, membranes, foams, monolithic bodies and ceramic matrix composites that are difficult to fabricate through traditional powder-processing. Fabrication by pyrolysis also provides the ease of processibility familiar to polymer and sol-gel science, and is processed under relatively low processing temperatures, i.e., less than 1200° C. Lowered processing temperature reduces the incidence of fiber damage in reinforced ceramic matrix composites. Thus, the pyrolysis process has been applied for the suitable fabrication of continuous fiber-reinforced ceramic composites (CFCCs).

The pyrolysis of cross-linked polymers is accompanied by the formation of gaseous reaction products, high volume shrinkage, and a pronounced density increase. Therefore, several (typically 6-10) cycles of polymer infiltration and pyrolysis (PIP) should be carried out to reduce porosity, increase densification, and produce large, un-cracked monolithic bodies. However, because of lengthy pyrolysis cycles, a lot of time is required in conventional PIP processing to produce a dense component, resulting in high-cost even for simple shaped products, which negates the numerous advantages of the pyrolysis fabrication approach.

To reduce processing time and provide a high production rate, non-conventional heating systems, such as laser heating, microwave heating, and thermal conversion processes, such as ion bombardment of thin films, have been applied to pyrolyze the polymer precursor. These novel processing techniques, especially microwave heating, provide a time and energy saving way for ceramic preparation. Until now, microwave-induced pyrolysis of preceramic polymers is still at the fundamental stage and has been confined to a research stage. Nevertheless, the potential for several promising features, including short processing time, uniformity of the products as well as tailoring particular design requirements of the materials is increasing. An appropriate control of the microwave heating parameters can also provide modified microstructure, different types of products, and enhanced reaction rates.

Therefore, an effective microwave heating process should be exploited in the pyrolysis of preceramic polymers to yield net-shaped components based on silicon carbide and other ceramics. One of problems has been the lack of effective coupling of microwave energy to the preceramic polymer during all stages of processing. Thus, hybrid microwave heating is primarily employed in which the microwave energy heats susceptors that then radiate heat to the material of interest. The possibility of fast heating using direct coupling of microwave energy has not been exploited. The commercial potential of microwave heating of preceramic polymers has not been realized due to the lack of the effective coupling of microwave energy with the preceramic polymer.

### SUMMARY OF THE INVENTION

Therefore, it is an aspect of the present invention to provide a direct and controlled coupling of microwave energy to actively seeded preceramic polymer throughout the pyrolysis of the material for the fabrication of silicon carbide and other ceramic based composites, including continuous fiber-reinforced ceramic composites (CFCC). Any conventional microwave source can be used or modified for the process. A seeding agent which is typically a metal/dielectric nanoscale-sized filler is also added to provide specific compositions with multifunctional properties to the ceramic component being fabricated.

The microwave processing method can apply to the microwave-induced pyrolysis of a polymer precursor that has been seeded with low volume fractions (up to about 5%) of nanometer sized metallic and/or dielectric fillers. The proper choice of the size of the filler particles, the volume content of the filler and the filler material type (metallic or dielectric) enables the effective direct coupling of the microwave energy to pyrolyze the preceramic polymer. Therefore, silicon carbide or other ceramic based materials can be fabricated over a time duration that is at least one order of magnitude less than that required for conventional oven processing of preceramic polymers. Furthermore, the inclusion of specific fillers can provide compositions with unique thermophysical properties.

A method for preparing a ceramic composite material of the present invention includes the steps of providing a preceramic polymer to a substantially small sized metallic or dielectric powder, mixing the preceramic polymer with the powder to form a mixture, and heating the mixture using microwave radiation in a controlled gas atmosphere to pyrolyze the mixture and convert the mixture to a ceramic composite.

### BRIEF DESCRIPTION OF THE DRAWINGS

The above and other objects, features and advantages of the present invention will become more apparent from the following detailed description when taken in conjunction with the accompanying drawings in which:

FIG. 1 is a graph illustrating a temperature rise for microwave induced heating of 10 g of neat polymer precursor at 100% microwave power according to the present invention;

FIG. 2 is a photograph illustrating a cured polymer precursor after microwave induced heating of 10 g of neat polymer precursor at 100% microwave power of FIG. 1;

FIG. 3 is a graph illustrating a variation of temperature as a function of time for the various slurries tested, where a volume fraction of 5% of 80 nm nickel particles is sufficient for an active seeding of the preceramic polymer to be pyrolyzed;

FIG. 4 is a graph illustrating a variation of temperature as a function of time for the various slurries tested, where a volume fraction of 10% of 17-23 μm aluminum particles is sufficient for an active seeding of the preceramic polymer to be pyrolyzed; and

FIG. 5 illustrates XRD analysis of 5% volume fraction of 80-nm Nickel particles in a SiC preceramic polymer after processing for pyrolyzed slurry and eight reinfiltration cycles.

### DETAILED DESCRIPTION OF THE PREFERRED EMBODIMENT

A preferred embodiment of the present invention will now be described in detail with reference to the annexed drawings. In the following description, a detailed description of known functions and configurations incorporated herein has been omitted for conciseness.

The present invention can be carried out using any fluid preceramic polymer and using any microwave source. The pyrolysis of preceramic polymers enables new types of ceramic materials to be processed at relatively low temperatures. The raw materials are element-organic polymers whose composition and architecture can be tailored and varied. First, during the pyrolysis of the precursors, amorphous materials are formed which have an atomically homogenous element distribution and represent a new class of materials with very interesting properties. Additionally, the amorphous material can be crystallized to stable or metastable phases by a second annealing, where nanocrystalline materials are formed. The microstructures of the nanocrystalline materials are stable at very high temperatures. Since the preceramic stage can be processed relatively easily using standard techniques of polymer processing technology to various material forms such as fibers, films, infiltrates, bulk material, etc. and components, the method of the present invention has a high application relevance in view of the technological characteristics of precursor pyrolysis processing.

The preceramic polymer (SMP-10, Starfire Systems) is pyrolyzed to form ultra high purity silicon carbide. First, the liquid polymer is cured by a cross-linking process at a temperature of 150-400° C. to form a green body. Subsequently, the cross-linked material is pyrolyzed at 800-900° C. to form an amorphous ceramic. Typically, the pyrolysis is carried out by heating the preceramic polymer in a conventional oven under a controlled atmosphere. While the microwave-induced pyrolysis process provides a time and cost efficient alternative to the conventional oven processing, the oscillatory heating of a preceramic polymer liquid by microwave radiation is effective only up to the cross-linking phase. Once the material is cross-linked, further heat generation by inter-molecular friction does not occur due to the inability of neighboring molecules to move relative to one another.

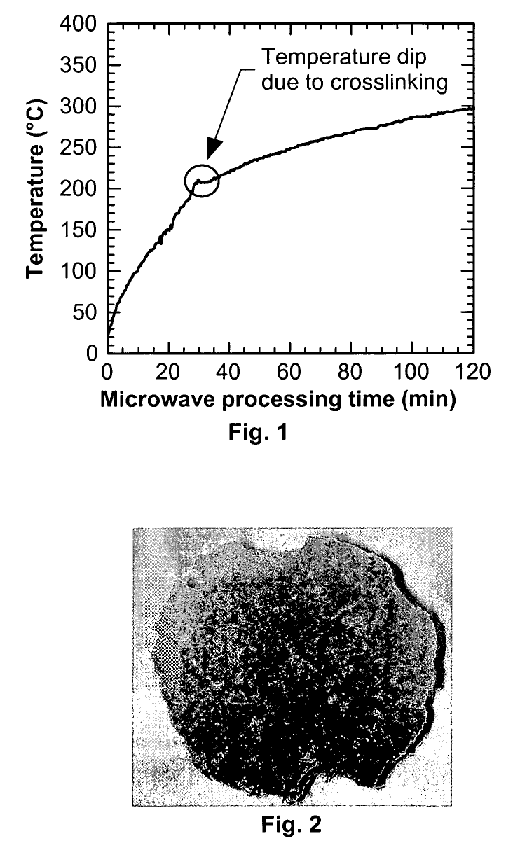

A substantial amount of the liquid preceramic polymer (10 g, 10 ml) is heated in the microwave oven using a possible maximum power of 100%. The liquid polymer precursor preferably is held in a high-alumina, microwave transparent crucible. FIG. 1 illustrates a temperature increase as a function of time under the processing conditions. First, the temperature of the polymer precursor steadily increases up to about 200° C. where the cross-linking reactions are initiated. Thus, the minor decrease in temperature (e.g., temperature dip) occurs due to cross-linking. The polymer is cured to form a solid green body that is mostly transparent to microwave radiation, and thus a further increase in temperature is greatly hindered. FIG. 2 illustrates a photograph of the cured polymer precursor of the present invention. The final temperature recorded after processing the polymer for 2 hours at maximum power is only about 300° C. The polymer precursor can not be pyrolyzed completely in the microwave oven and necessitates the use of active fillers.

Various nanometer and micrometer sized metal powders have been evaluated as active fillers for enhancing the microwave coupling required for efficient pyrolysis of the polymer precursor. The information regarding the microwave-induced heating of nanometer- and micrometer-sized metal powders is not readily available. Therefore, the heating characteristics of various powders of interest are obtained from the experimentation. The critical factors for obtaining the choice of appropriate fillers are high-temperature characteristics, chemical and/or mechanical interaction with silicon carbide, and shape, size and form of the fillers. The metallic filler materials can include any micrometer- or nanometer-sized powders. The fillers include micrometer-sized powders of tungsten (W, 40 μm), nickel (Ni, 40 μm), titanium (Ti, 40 μm), molybdenum (Mo, 40 μm), copper (Cu, 40 μm), iron (Fe, 40 μm), and aluminum (Al, 17-23 μm), and nanometer-sized powders of tungsten (W, 60-80 nm), nickel (Ni, 80 nm), molybdenum (Mo, 80 nm), and aluminum (Al, 20-100 nm). Dielectric powder fillers can also be used, for example, silicon carbide micrometer-sized powders and nanometer-sized powders.

An appropriate volume fraction of filler is required to serve as a distributed, volumetric source of thermal energy in the polymer precursor and aid in the pyrolysis process. Various amounts of filler particles are dispersed in a predetermined amount of precursor using ultrasonication or another suitable procedure. The nanoscale fillers help to form uniform suspensions that are stable even at very low volume fractions. The slurries are then processed in the microwave oven.

Any commercial microwave source and modified oven can be used for this process. The microwave-processing oven is provided with an inert or reactive gas purge system to provide a controlled atmosphere during pyrolysis, and a venting system to remove hydrogen gas and other byproducts produced during pyrolysis. The processing chamber should be provided with an insulation material which is transparent to microwave radiation to contain a hot processing zone. The true microwave power is controlled using a voltage controller that modulates the input into the high-voltage transformer driving the magnetron. Other closed or open loop types of controls can also be employed to modulate the processing conditions as desired and prevent thermal runaway.

The first pyrolysis of slurries containing the filler particles produces porous foams due to the large quantities of the polymer precursor involved. The pyrolyzed foams are ground using a planetary ball mill or other techniques. The resulting powder consists of the active filler which is well dispersed in amorphous silicon carbide (α-SiC). The powders are mixed with the polymer precursor, compacted to form preforms, and then subjected to further microwave processing. The preforms can incorporate any fiber or other reinforcement agents such as whiskers and particles. Alternatively, the original slurry can be pyrolyzed under pressure to directly yield a preform.

The preforms are heated in the microwave oven. The pyrolyzed preforms are reinfiltrated with the liquid polymer followed by curing and pyrolyzing to increase material density. Typically, 6-10 reinfiltration cycles are required to achieve optimal densification and helium-tight porosity. A lower number of cyles can be used to yield a material with controlled open and closed porosity. The presence of amorphous SiC carbide in subsequent reinfiltration cycles does not contribute to microwave absorption and volumetric heating. Amorphous SiC, unlike crystalline SiC, is a very poor absorber of microwave energy due to greatly different dielectric properties. The active seeding directly leads to microwave absorption and the resulting pyrolysis throughout the reinfiltration cycles.

### EXAMPLE 1

This example demonstrates microwave-induced pyrolysis of the preceramic polymer using 80 nm sized nickel particles.

A powder of 80 nanometer diameter nickel particles was suspended in 5 grams of preceramic polymer of silicon carbide at substantial volume fractions ranging from 0.04% to 5%, and then subjected to microwave processing. The preceramic polymer for silicon carbide employed is the SP-matrix precursor from Starfire Systems, Inc. (Malta, N.Y.). The SP-matrix polymer is an allylhydridopolycarbosilane, which is an amber liquid with a viscosity of 80-150 cps at 20° C. This polymer is cured by a cross-linking process at a temperature of 150-400° C. to form a green body, and is pyrolyzed at about 800° C. to form fully ceramic, amorphous SiC, and yields nanocrystalline SiC at about 1250° C. The SP-matrix preceramic polymer is a commercially available ultra-high purity precursor for fabricating silicon carbide while providing a high ceramic yield.

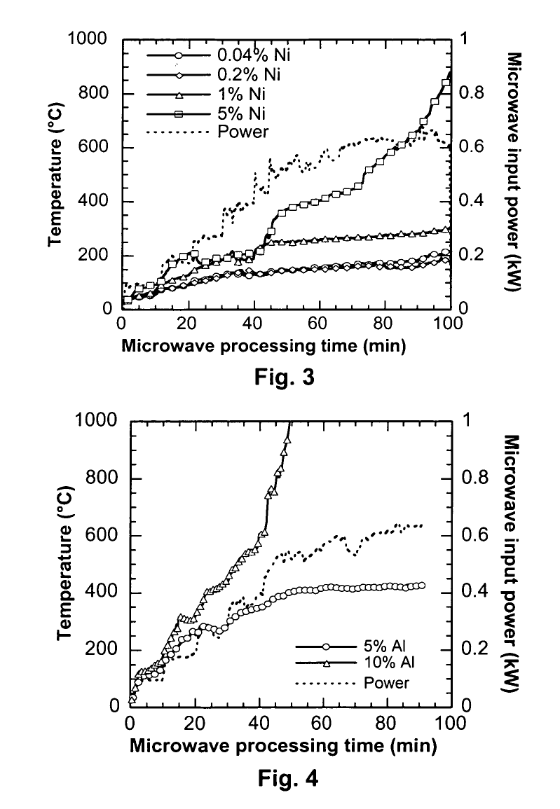

The power routine employed was 10 min. at 90 W, 10 min. at 180 W, 10 min. at 260 W, 60 min. at 320-620 W, and 10 min. at 620 W. FIG. 3 illustrates the variation of temperature as a function of time for the various slurries tested, where a volume fraction of 5% for 80 nm nickel particles is sufficient for the active seeding of the preceramic polymer to pyrolyze.

### EXAMPLE 2

This example demonstrates microwave-induced pyrolysis of the preceramic polymer using 17-23 μm sized aluminum particles. A powder of 17-23 μm diameter aluminum particles was suspended in 5 grams of the preceramic polymer of silicon carbide at volume fractions 5% and 10%, and then subjected to microwave processing. The preceramic polymer for silicon carbide employed is the SP-matrix precursor from Starfire Systems, Inc. (Malta, N.Y.).

The power control employed was 10 min. at 90 W, 10 min. at 180 W, 10 min. at 260 W, 60 min. at 320-620 W, and 10 min. at 620 W. FIG. 4 illustrates the variation of temperature as a function of time for the various slurries tested, where a volume fraction of 10% for 17-23 μm aluminum particles is sufficient for the active seeding of the preceramic polymer to pyrolyze.

### EXAMPLE 3

In this example, the resulting pyrolyzed foam prepared from Example 1 was ground using a planetary ball mill in a tungsten carbide bowl (WC) with 10 mm WC balls for 5 minutes. The resulting powder consisted of the active nickel filler which was well dispersed in amorphous silicon carbide (α-SiC). Then, the powder was mixed with small quantities of the polymer precursor and compacted under a pressure 90 MPa to form φ25×30 mm preforms. The compression press is preferably setup inside an argon glove box for compacting under an inert atmosphere.

The preforms were heated in the microwave oven using the same power control as described above, which completely pyrolyzed the polymer precursor. The pyrolyzed preforms were reinfiltrated with the liquid polymer followed by curing and pyrolyzing to increase material density for a total of eight cycles.

The fabricated materials were analyzed using powder X-ray diffraction (XRD). The measurements can identify crystalline species in the material of interest and were carried out on the following materials at different stages of processing in order to determine any evolution of microstructure.

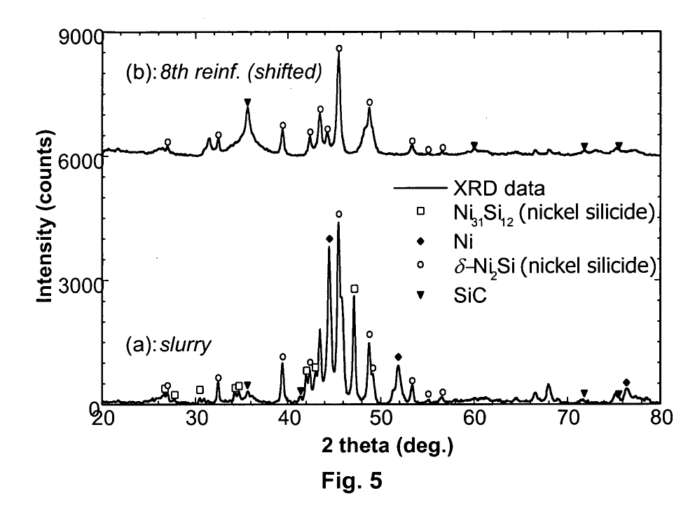

FIG. 5 shows XRD analysis obtained for material prepared using 80 nm nickel particles. The presence of solid-state reactions was observed in both traces. Furthermore, details of material evolution were obtained by a comparison of the two plots. In FIG. 5(a), the predominant species are two types of nickel silicide (Ni₃₁S₁₂ and Ni₂Si) and elemental Nickel (Ni). The nickel silicides were formed by the reaction of Ni with SiC. The reactions were not completed, since there was still evidence of some Ni phase. Little evidence of SiC was observed implying that the silicon carbide formed by pyrolysis is amorphous (α-SiC) and thus did not show up in XRD analysis. After eight reinfiltration cycles, the reaction was complete and all the Ni and Ni₃₁Si₁₂ had been converted to Ni₂Si, as shown in FIG. 5(b). Also, the presence of SiC was observed implying that some crystalline β-SiC was formed along with the amorphous α-SiC.

While the invention has been shown and described with reference to a certain preferred embodiment thereof, it will be understood by those skilled in the art that various changes in form and details may be made therein without departing from the spirit and scope of the invention.

What is claimed is:

1. A method for preparing a ceramic composite material, comprising the steps of:
providing a preceramic polymer to a substantially small sized metallic or dielectric filler powder;
mixing the preceramic polymer with the powder to form a mixture; and
heating the mixture using microwave radiation in a controlled gas atmosphere to pyrolyze the mixture and convert the mixture to a first ceramic composite.

2. The method of claim 1, further comprising the steps of:
grinding the first ceramic composite into a powder;
mixing the first ceramic composite powder with an additional preceramic polymer to form a mixture; and
heating the mixture using microwave radiation in an inert gas atmosphere to pyrolyze the mixture and convert the mixture to a second ceramic composite.

3. The method of claim 2, further comprising the steps of:
reinfiltrating the second ceramic composite with the preceramic polymer;
heating the second ceramic composite using microwave radiating in an inert gas atmosphere; and
repeating the reinfiltrating and heating steps until the composite is densified to a predetermined level.

4. The method of claim 1, wherein the microwave radiation is from a conventional microwave source of 2.45 GHz.

5. The method of claim 2, wherein the microwave radiation is from a conventional microwave source of 2.45 GHz.

6. The method of claim 3, wherein the microwave radiation is from a conventional microwave source of 2.45 GHz.

7. The method of claim 1, wherein the metallic or dielectric filler powder is a susceptor for the preceramic polymer and the resulting amorphous silicon carbide.

8. The method of claim 1, wherein a particle size, a volume and a material type of the filler powder are determined to provide a substantially effective direct coupling of the microwave radiation to pyrolyze the preceramic polymer with the predetermined thermophysical properties.

9. The method of claim 1, wherein the filler powder is further incorporated with a fiber-reinforcement material.

10. The method of claim 3, wherein the substantially densified ceramic composite is a solution of silicon carbide and metallic carbide.

11. The method of claim 1, wherein the first ceramic composite further includes unique compounds due to chemical reactions of the filler powder and the preceramic polymer.

12. The method of claim 2, wherein the second ceramic composite further includes unique compounds due to chemical reactions of the filler powder and the preceramic polymer.

13. The method of claim 3, wherein the substantially densified ceramic composite further includes unique compounds due to chemical reactions of the filler powder and the preceramic polymer.

14. The method of claim 1, wherein the preceramic polymer is seeded with substantially low volume fractions of the nanometer-sized filler powder.

15. The method of claim 14, wherein the volume fraction of the filler powder is up to about 5%.

16. The method of claim 1, wherein the heating step of the mixture is processed under pressure to directly form a preform.

17. The method of claim 2, further comprising the steps of:
compacting the mixture under pressure to form a preform.

18. A method for joining ceramic elements, comprising the steps of:
providing a preceramic polymer to a substantially small sized metallic or dielectric filler powder;
mixing the preceramic polymer with the filler powder to form a mixture;
providing the mixture into a predetermined portion between adjoining ceramic elements to join the ceramic elements; and
heating the mixture using microwave radiation in a controlled gas atmosphere to pyrolyze the mixture into a ceramic composite thereby joining the ceramic elements.

19. The method of claim 18, further comprising the steps of:
reinfiltrating the ceramic composite with an additional preceramic polymer;
heating the ceramic composite using microwave radiation in an inert gas atmosphere; and
repeating the reinfiltrating and heating steps until the ceramic composite is densified to a predetermined level of strength.
